(19) United States
(12) Patent Application Publication
(10) Pub. No.: US 2010/0289985 A1
(43) Pub. Date: Nov. 18, 2010

(54) ILLUMINATION UNIT AND DISPLAY DEVICE WITH THE ILLUMINATION UNIT

(75) Inventors: Yoshihide NISHIDA, Tokyo (JP); Yuji TSUCHIYAMA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/772,384

(22) Filed: May 3, 2010

(30) Foreign Application Priority Data
May 18, 2009 (JP) 2009-119679
Apr. 5, 2010 (JP) 2010-086684

(51) Int. Cl. G02F 1/1335; F21V 8/00

(52) U.S. Cl. 349/64; 362/617

(57) ABSTRACT

An illumination unit of the present invention includes: a light guide plate; a point light source for illuminating at least one side surface of the light guide plate; and an anisotropic light diffuser provided between the light guide plate and the point light source for diffusing light emitted from the point light source. The anisotropic light diffuser has anisotropy by which a degree of diffusion differs depending on directions. The anisotropic light diffuser is an anisotropic light diffusion sheet with a particulate dispersion phase defined in an anisotropic light diffusion layer thereof.

### BACKGROUND OF THE INVENTION

1. Field of the Invention

The present invention relates to an illumination unit for illuminating a liquid crystal display panel and the like from the back side thereof.

2. Description of the Background Art

When a light source in the form of a point in outline such as an LED is employed as a light source for illuminating a light guide plate from a side surface thereof arranged on the same side as the back side of a liquid crystal display panel, a short distance between the point light source and a light receiving surface of the light guide plate prevents spread of light. This generates nonuniformity of brightness in a display surface at a region close to the light source.

Light should uniformly be diffused in the light guide plate provided to the back side of the liquid crystal display panel in order to provide uniformity of brightness in the display surface of the liquid crystal display panel. However, placing the point light source away from the light receiving surface of the light guide plate for obtaining uniformity of brightness in the light guide plate corresponding to that in the display surface results in size increase of the illumination unit. This will hinder downsizing of the illumination unit.

Document 1 (Japanese Patent Application Laid-Open No. 2004-241237) discloses provision of air lenses in a light guide plate. In Document 1, provision of the air lenses is intended to achieve uniform diffusion of light in the light guide plate with a point light source remaining close to a light receiving surface of the light guide plate. Document 2 (Japanese Patent Application Laid-Open No. 2008-034234) discloses provision of an anisotropic adhesive to a surface of a light guide plate that receives light emitted from a point light source.

A conventional illumination unit using a point light source cannot provide uniform distribution of brightness in a display surface unless the point light source and a light receiving surface of a light guide plate are sufficiently distanced. This results in a problem of size increase of the illumination unit.

Provision of the air lenses in the light guide plate disclosed in Document 1, which is intended to overcome this problem, disadvantageously requests complicated process. Provision of the anisotropic adhesive to the light receiving surface of the light guide plate disclosed in Document 2 involves needle fillers that are to be diffused in the adhesive. The needle fillers have an index of refraction different from that of the adhesive, and are intended to achieve anisotropy. However, the needle fillers are subjected to size constraints. More specifically, the major diameter of the needle fillers not greater than 2 μm or not less than 5,000 μm makes it difficult to achieve proper diffusion and orientation of light, imposing limitation in enhancing anisotropy. Besides, an adhesive side of the adhesive is exposed. So, a foreign object entering from outside will be attached to the adhesive, and will then cut off light emitted from a light source. This disadvantageously results in light loss, or generates a black spot appearing on a display surface.

### SUMMARY OF THE INVENTION

It is an object of the present invention to provide an illumination unit capable of providing uniformity of brightness in a display surface without requiring any complicated process even when a point light source and a light receiving surface of a light guide plate are close to each other. It is also an object of the present invention to provide a display device with the illumination unit.

The illumination unit of the present invention includes a light guide plate, a point light source, and an anisotropic light diffuser. The point light source illuminates at least one side surface of the light guide plate. The anisotropic light diffuser is provided between the light guide plate and the point light source for diffusing light emitted from the point light source, and has anisotropy by which a degree of diffusion differs depending on directions. The anisotropic light diffuser is an anisotropic light diffusion sheet with a particulate dispersion phase defined in an anisotropic light diffusion layer thereof.

Provision of the anisotropic light diffuser between the point light source and the light guide plate allows light emitted from the point light source to be diffused throughout the light guide plate even when the point light source and the light guide plate are close to each other. This provides uniformity of brightness in a display surface, thereby realizing downsizing of the illumination unit.

The display device of the present invention includes the illumination unit of the present invention and a liquid crystal panel. The liquid crystal panel is illuminated with the illumination unit.

The illumination unit of the present invention and a liquid crystal panel constitute the display device. So, uniformity of brightness in a display surface is provided, thereby realizing downsizing of the display device.

### BRIEF DESCRIPTION OF THE DRAWINGS

FIG. 1 is an exploded perspective view of an illumination unit of a first preferred embodiment of the present invention;

FIG. 2 is a sectional view of the illumination unit of the first preferred embodiment;

FIGS. 3A and 3B each show how a light diffuser works;

FIG. 4 is a sectional view of an illumination unit of a second preferred embodiment of the present invention;

FIG. 5 is an exploded perspective view of an illumination unit that constitutes a precursor technique;

FIG. 6 is a sectional view of the illumination unit of the precursor technique;

FIG. 7 is a sectional view of an illumination unit of a third preferred embodiment of the present invention;

FIG. 8 is a perspective view of the illumination unit of the third preferred embodiment; and

FIG. 9 is a perspective view of an anisotropic light diffusion sheet.

### DESCRIPTION OF THE PREFERRED EMBODIMENTS

### First Preferred Embodiment

<Precursor Technique>

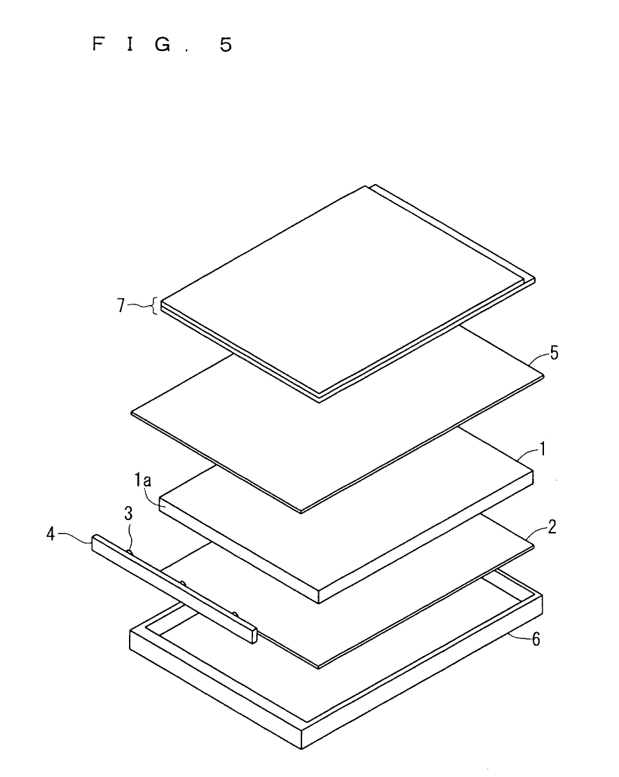

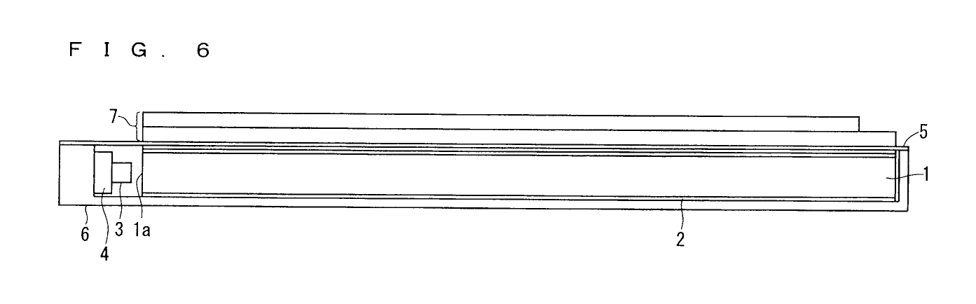

FIG. 5 is an exploded perspective view of an illumination unit and a liquid crystal panel to be used in a liquid crystal display device that constitute a precursor technique of the present invention. FIG. 6 is a sectional view of the illumination unit shown in FIG. 5

As shown in FIG. 5, the illumination unit of the precursor technique includes: a light guide plate 1 with a surface (non-illuminated surface) opposite to an illuminated surface thereof and on which a light diffusion pattern is formed (printed); a reflection sheet 2 arranged on the same side as the non-illuminated surface of the light guide plate 1; a light source unit 4 arranged along a side surface 1a of the light guide plate 1; point light sources 3 in the form of points in outline attached to the light source unit 4; a plurality of optical sheets 5 arranged on the same side as the illuminated surface of the light guide plate 1; and a frame 6 holding the light guide plate 1, the reflection sheet 2, the light source unit 4, and the optical sheets 5.

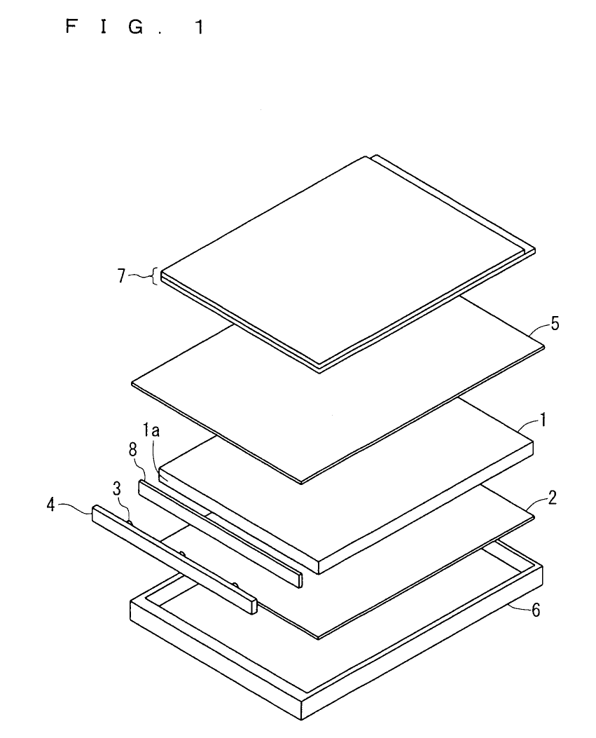

The liquid crystal panel 7 is illuminated with light passing through the light guide plate 1 and the optical sheets 5, during which the above-described problems occur. An illumination unit of a first preferred embodiment of the present invention overcomes these problems, and the structure of which is described in detail with reference to FIGS. 1 to 3.

<Structure>

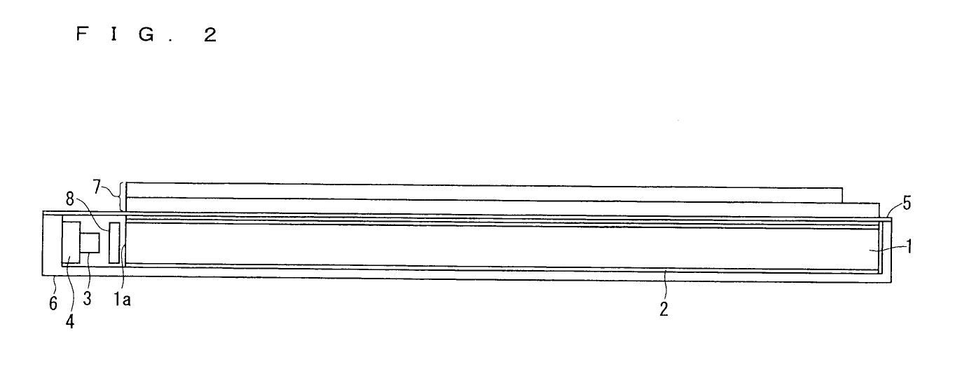

FIGS. 1 and 2 are exploded perspective and sectional views respectively of a display device with an illumination unit of the first preferred embodiment. The illumination unit of the first preferred embodiment includes: a light guide plate 1; a reflection sheet 2 arranged on the same side as a non-illuminated surface of the light guide plate 1; a light source unit 4 arranged along a light receiving surface 1a as one of side surfaces of the light guide plate 1; point light sources 3 in the form of points in outline such as light-emitting diodes or optical fibers attached to the light source unit 4; a plurality of optical sheets 5 arranged on the same side as an illuminated surface of the light guide plate 1; a frame 6 holding the light guide plate 1, the reflection sheet 2, the light source unit 4, and the optical sheets 5; and an anisotropic light diffuser 8 provided between the light receiving surface 1a of the light guide plate 1 and the point light sources 3. A liquid crystal panel 7 is provided in front of the optical sheets 5 in the illumination unit of this structure, thereby forming a display device.

<Anisotropic Light Diffuser>

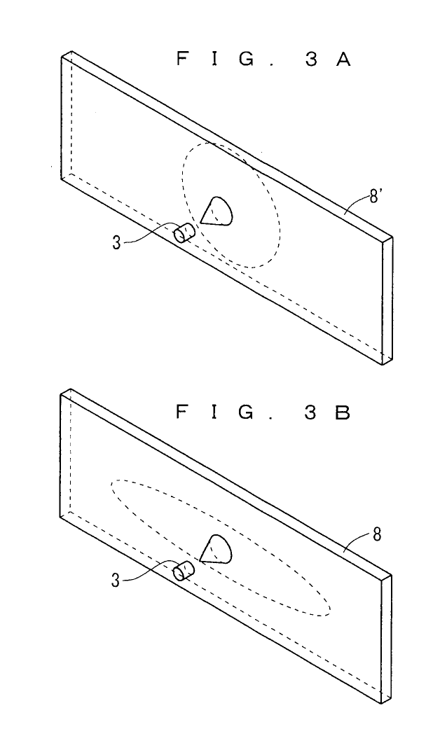

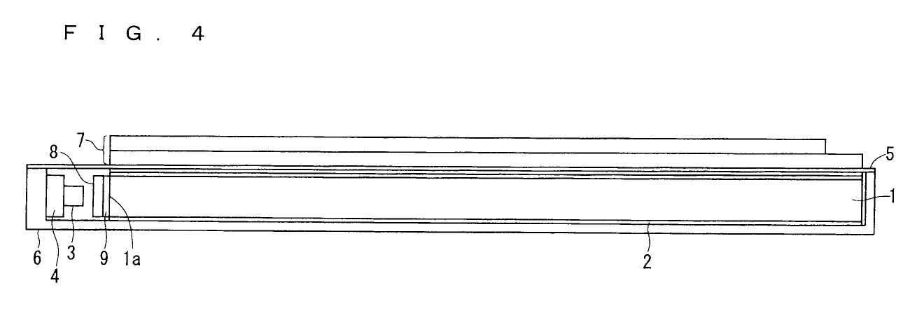

The effect of the anisotropic light diffuser 8 is described with reference to FIGS. 3A and 3B. FIGS. 3A and 3B each show how light emitted from the point light source 3 is spread while passing through a light diffuser. FIG. 3A shows spread of light passing through an isotropic light diffuser 8′. FIG. 3B shows spread of light passing through the anisotropic light diffuser 8.

As shown in FIG. 3A, light emitted from the point light source 3 is isotropically diffused after passing through the isotropic light diffuser 8′, and is then spread in a circle. In contrast, the anisotropic light diffuser 8 provides a degree of diffusion that differs depending on directions. So, light is spread in an ellipse as shown in FIG. 3B.

In FIG. 1, the light receiving surface 1a of the light guide plate 1 along which the point light sources 3 are arranged is substantially rectangular. So, in the first preferred embodiment, provision of the isotropic light diffuser 8′ as shown in FIG. 3A causes light emitted from each of the point light sources 3 to be spread in a circle. As a result, part of the light spread in the direction of the thickness of the light guide plate 1 is lost, thereby reducing the efficiency of use of light.

In response, in the first preferred embodiment, the anisotropic light diffuser 8 shown in FIG. 3B is provided between the light receiving surface 1a of the light guide plate 1 and the point light sources 3. The anisotropic light diffuser 8 has a smaller degree of diffusion in the direction of the width, and a greater degree of diffusion in the direction of the length perpendicular to the direction of the width of the light receiving surface 1a of the light guide plate 1. So, light emitted from each of the point light sources 3 is diffused in an ellipse in the light guide plate 1. This prevents nonuniformity of brightness in a display surface even when the point light sources 3 are arranged close to the light receiving surface 1a of the light guide plate 1, thereby realizing downsizing of the illumination unit and enhancing the efficiency of use of light.

An isotropic light diffusion sheet is employed as the anisotropic light diffuser 8. FIG. 9 is a perspective view of the anisotropic light diffusion sheet 8. As shown in FIG. 9, the anisotropic light diffusion sheet 8 includes an anisotropic light diffusion layer 8b made of a material such as resin in which particulate dispersion phases 8e extending in the same direction as the direction of the thickness of the light guide plate 1 are provided, and transparent resin layers 8a and 8c as laminated films provided on opposite sides or one side of the anisotropic light diffusion layer 8b. The transparent resin layers 8a and 8c are provided with recesses, protrusions, or both recesses and protrusions defined in their respective surfaces and which are arranged in the same direction as the direction in which the particulate dispersion phases 8e extend. This achieves a higher level of anisotropy. Further, uniaxial drawing of the sheet during its processing results in higher aspect ratio of the particulate dispersion phases 8a, so that a still higher level of anisotropy is achieved. The particulate dispersion phases 8a are not subjected to size constraints, so that they can be shaped in a way that provides desirable anisotropy.

As described above, the illumination unit of the first preferred embodiment includes: the light guide plate 1; the point light sources 3 for illuminating at least one side surface of the light guide plate 1; and the anisotropic light diffuser 8 provided between the light guide plate 1 and the point light sources 3 for diffusing light emitted from each of the point light sources 3. The anisotropic light diffuser 8 has anisotropy by which a degree of diffusion differs depending on directions. The anisotropic light diffuser 8 is an anisotropic light diffusion sheet with a particulate dispersion phase defined in an anisotropic light diffusion layer thereof. Thus, nonuniformity of brightness in a display surface is prevented even when the point light sources 3 are arranged close to the light receiving surface 1a of the light guide plate 1, thereby realizing downsizing of the illumination unit.

The anisotropic light diffusion sheet 8 has a smaller degree of diffusion in the direction of the width, and a greater degree of diffusion in the direction of the length of a side surface (light receiving surface) 1a of the light guide plate 1. This causes light emitted from each of the point light sources 3 to be diffused rapidly in the direction of the length of the light receiving surface 1a of the light guide plate 1. Thus, nonuniformity of brightness in a display surface is prevented even when the point light sources 3 are arranged close to the light receiving surface 1a of the light guide plate 1, thereby realizing downsizing of the illumination unit.

The display device of the first preferred embodiment includes the illumination unit described above, and a liquid crystal panel to be illuminated with the illumination unit. So, downsizing of the display device is realized while nonuniformity of brightness in a display surface is prevented.

<Effect>

The effect achieved by the illumination unit of the first preferred embodiment is described above, and is summarized as follows. That is, the illumination unit includes the anisotropic light diffuser 8 provided between the light guide plate 1 and the point light sources 3 for diffusing light emitted from each of the point light sources 3. The anisotropic light diffuser 8 has anisotropy by which a degree of diffusion differs depending on directions. The anisotropic light diffuser 8 is the anisotropic light diffusion sheet 8 with a particulate dispersion phase defined in an anisotropic light diffusion layer thereof. Thus, nonuniformity of brightness in a display surface is prevented even when the point light sources 3 are arranged close to the light receiving surface 1a of the light guide plate 1, thereby realizing downsizing of the illumination unit.

The anisotropic light diffuser 8 has a smaller degree of diffusion in the direction of the width, and a greater degree of diffusion in the direction of the length of a side surface (light receiving surface) 1a of the light guide plate 1. This causes light emitted from each of the point light sources 3 to be diffused rapidly in the direction of the length of the light receiving surface 1a of the light guide plate 1. Thus, nonuniformity of brightness in a display surface is prevented even when the point light sources 3 are arranged close to the light receiving surface 1a of the light guide plate 1, thereby realizing downsizing of the illumination unit.

The anisotropic light diffusion sheet 8 includes the transparent resin layers 8a and 8c (laminated films) provided on opposite sides or one side of the anisotropic light diffusion layer 8b. The laminated films are provided with recesses, protrusions, or both recesses and protrusions defined in their respective surfaces and which are arranged in the same direction as the direction in which the particulate dispersion phases 8e extend. This provides a higher level of anisotropy to the anisotropic light diffusion sheet 8.

The display device of the first preferred embodiment includes the illumination unit described above, and a liquid crystal panel to be illuminated with the illumination unit. So, downsizing of the display device is realized while nonuniformity of brightness in a display surface is prevented.

### Second Preferred Embodiment

<Structure>

FIG. 4 is a sectional view of a display device with an illumination unit of a second preferred embodiment of the present invention. In FIG. 4, constituent elements corresponding to those of the first preferred embodiment are designated by the same reference numerals. The second preferred embodiment differs from the first preferred embodiment in that a highly transparent double-sided adhesive tape 9 is employed as an adhesive with which the anisotropic light diffuser 8 is attached to the light receiving surface 1a of the light guide plate 1. The structure of the second preferred embodiment is otherwise the same as that of the first preferred embodiment, and is not described accordingly.

As an example, Optical Clear Adhesive Tape of Sumitomo 3M Limited is employed as the double-sided adhesive tape 9. The anisotropic light diffuser 8 is attached with the double-side adhesive tape 9 to the light receiving surface 1a of the light guide plate 1. This prevents shift of the optical axis of the anisotropic light diffuser 8, so that light spread in an ellipse from each of the point light sources 3 is allowed to efficiently enter the light receiving surface 1a of the light guide plate 1.

As described above, the illumination unit of the second preferred embodiment further includes an adhesive (double-sided adhesive tape 9) with which the anisotropic light diffuser 8 is attached to the side surface (light receiving surface) 1a of the light guide plate 1. This prevents shift of the optical axis of the anisotropic light diffuser 8, so that light emitted from each of the point light sources 3 and spread in an ellipse is allowed to efficiently enter the light receiving surface 1a of the light guide plate 1.

<Effect>

The effect achieved by the illumination unit of the second preferred embodiment is described above, and is summarized as follows. That is, the illumination unit of the second preferred embodiment further includes an adhesive (double-sided adhesive tape 9) with which the anisotropic light diffuser 8 is attached to a side surface (light receiving surface) 1a of the light guide plate 1. This prevents shift of the optical axis of the anisotropic light diffuser 8, so that light spread in an ellipse from each of the point light sources 3 is allowed to efficiently enter the light receiving surface 1a of the light guide plate 1.

### Third Preferred Embodiment

<Structure>

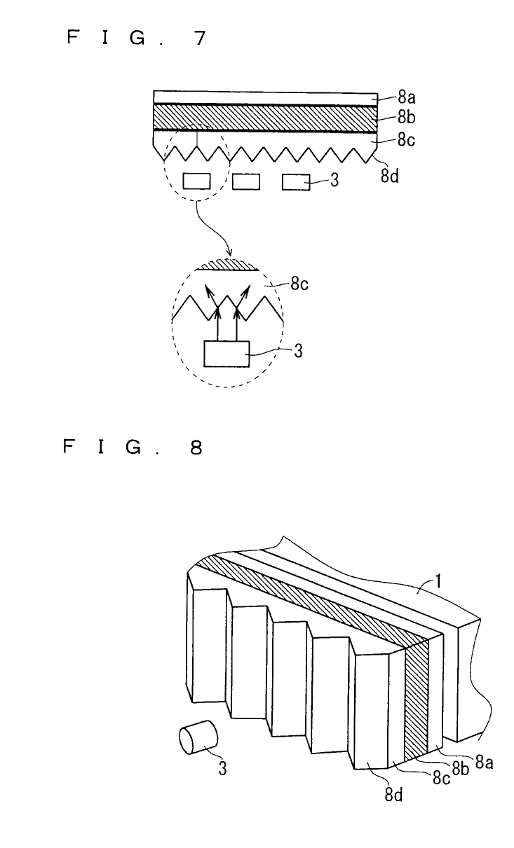

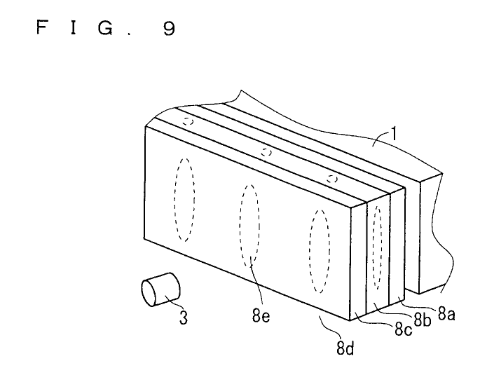

FIGS. 7 and 8 are sectional and perspective views respectively of a display device with an illumination unit of a third preferred embodiment of the present invention. In FIGS. 7 and 8, constituent elements corresponding to those of the first preferred embodiment are designated by the same reference numerals. As already described, the anisotropic light diffusion sheet 8 includes the transparent resin layers 8a and 8c as laminated films provided on opposite sides or one side of the anisotropic light diffusion layer 8b. In the third preferred embodiment, lens shapes 8d are formed in a surface of the transparent resin layer 8c. Formation of the lens shapes 8d in the transparent resin layer 8c provides a still higher level of anisotropy. The third preferred embodiment differs from the first preferred embodiment in that the lens shapes 8d are formed in the transparent resin layer 8c that constitutes the anisotropic light diffuser 8. The structure of the third preferred embodiment is otherwise the same as that of the first preferred embodiment, and is not described accordingly.

The surface of the transparent resin layer 8c in which the lens shapes 8d are formed is opposed to the point light sources 3. Further, the plurality of lens shapes 8d that are rectangular in cross section are arranged in a way that they extend in the same direction as the direction in which the particulate dispersion phases 8e in the anisotropic light diffusion layer 8b extend, and that they are aligned in a direction (direction of the length of the light receiving surface 1a) perpendicular to the direction in which the particulate dispersion phases 8e extend.

As described above, in the illumination unit of the third preferred embodiment, the anisotropic light diffusion sheet 8 includes the laminated film 8c which is arranged on a surface of the anisotropic light diffusion layer 8b opposed to the point light sources 3, and in which the lens shapes 8d are formed. As shown in FIG. 7, this structure allows light emitted from each of the point light sources 3 to enter the laminated film while being refracted at one surface of the lens shapes 8d. The light is thereafter diffused in the direction of the length. So, when combined with the anisotropic light diffusion layer 8b, this allows the light to be diffused further in the direction of the length.

As in the second preferred embodiment, the anisotropic light diffuser 8 may be attached with the double-side adhesive tape 9 to a side surface of the light guide plate 1.

<Effect>

The effect achieved by the illumination unit of the third preferred embodiment is described above, and is summarized as follows. That is, in the illumination unit of the third preferred embodiment, the anisotropic light diffusion sheet 8 includes the laminated film 8c which is arranged on a surface of the anisotropic light diffusion layer 8b opposed to the point light sources 3, and in which the lens shapes 8d are formed. Light emitted from each of the point light sources 3 enters the laminated film while being refracted at one surface of the lens shapes 8d, and is thereafter diffused in the direction of the length. So, when combined with diffusion effect achieved by the anisotropic light diffusion layer 8b, this realizes downsizing of the display device while preventing nonuniformity of brightness in a display surface. Further, adjacent ones of the point light sources 3 can sufficiently be distanced so that the number of point light sources can be reduced. This results in cost reduction even when downsizing of the display device is not intended.

While the invention has been shown and described in detail, the foregoing description is in all aspects illustrative and not restrictive. It is therefore understood that numerous modifications and variations can be devised without departing from the scope of the invention.

What is claimed is:

1. An illumination unit, comprising:
a light guide plate;
a point light source for illuminating at least one side surface of said light guide plate; and
an anisotropic light diffuser provided between said light guide plate and said point light source for diffusing light emitted from said point light source, said anisotropic light diffuser having anisotropy by which a degree of diffusion differs depending on directions, wherein
said anisotropic light diffuser is an anisotropic light diffusion sheet with a particulate dispersion phase defined in an anisotropic light diffusion layer thereof.

2. The illumination unit according to claim 1, wherein said anisotropic light diffusion sheet has a smaller degree of diffusion in the direction of the width, and a greater degree of diffusion in the direction of the length of said side surface of said light guide plate.

3. The illumination unit according to claim 2, wherein
said anisotropic light diffusion sheet includes a laminated film provided on opposite sides or one side of said anisotropic light diffusion layer, and
said laminated film is provided with recesses, protrusions, or both recesses and protrusions defined in a surface thereof and which are arranged in the same direction as the direction in which said particulate dispersion phase extends.

4. The illumination unit according to claim 2, wherein said anisotropic light diffusion sheet includes a laminated film which is arranged on a surface of said anisotropic light diffusion layer opposed to said point light source, and in which a lens shape is formed.

5. The illumination unit according to claim 2, further comprising an adhesive with which said anisotropic light diffusion sheet is attached to said side surface of said light guide plate.

6. A display device comprising:
the illumination unit as recited in claim 2; and
a liquid crystal panel to be illuminated with said illumination unit.
